(19) United States
(12) Patent Application Publication
(10) Pub. No.: US 2018/0314356 A1
(43) Pub. Date: Nov. 1, 2018

(54) METHOD FOR SENSING A STYLUS ON A DISPLAY DEVICE AND A DEVICE FOR SENSING A STYLUS

(71) Applicant: ELAN MICROELECTRONICS CORPORATION, Hsinchu (TW)

(72) Inventors: Jyun-Yu Chen, New Taipei City (TW); Hsuan-Wen Tseng, New Taipei City (TW); Chia-Hsing Lin, Hsinchu City (TW)

(73) Assignee: ELAN MICROELECTRONICS CORPORATION, Hsinchu (TW)

(21) Appl. No.: 15/665,160

(22) Filed: Jul. 31, 2017

(30) Foreign Application Priority Data
Apr. 27, 2017 (TW) 106114159

(51) Int. Cl. G06F 3/044; G06F 3/0354

(52) U.S. Cl. CPC G06F 3/044; G06F 3/03547; G06F 3/03545

(57) ABSTRACT

The present invention relates to a method for sensing a stylus on a display device and a device for using the same. The display device has multiple sub-pixels and multiple common electrodes respectively corresponding to at least one of the sub-pixels. In the sensing stylus method, a signal of an active stylus is sensed through one of the common electrodes for displyaing an image in a displaying duration of the display device.

### CROSS-REFERENCE TO RELATED APPLICATIONS

This application is based upon and claims priority under 35 U.S.C. 119 from Taiwan Patent Application No. 106114159 filed on Apr. 27, 2017, which is hereby specifically incorporated herein by this reference thereto.

### BACKGROUND OF THE INVENTION

### 1. Field of the Invention

The present invention relates to a touch display device, specifically related to a method for sensing an active stylus on a display device and a device for sensing an active stylus.

### 2. Description of the Prior Arts

An in-cell touch display device has a display panel with a common electrode layer. The common electrode layer is used as multiple touch sensing electrodes, so a time-division display-driving and touch-scanning method is employed for display driving and touch sensing. In the time-division display-driving and touch-scanning method, a duration (16.67 ms) of an image displaying period (1/60 Hz) of the display panel is divided into a displaying duration and a touch sensing duration. Since the touch sensing duration corresponds to a vertical blanking interval (VBI) of the display panel, an image displayed on the display panel is not affected by the touch sensing. During the displaying duration, the common electrode layer of the display panel is used to display an image. However, during the touch sensing duration, the common electrode layer is used to sense a touch object.

If the in-cell touch display device further adds a function of sensing an active stylus, the duration of the image displaying period has to be further divided into another duration to sense the active stylus. However, the duration of the image displaying period is fixed in general, which is 16.67 ms, the displaying duration has to be shortened if the touch sensing duration is prolonged to sense the active stylus. The image quality of the display panel may be affected accordingly. In another way, the displaying duration is maintained to keep a good image quality, but the time of sensing the touch object in the touch sensing duration has to be shortened and the rest time of the touch sensing duration is used to sense the active stylus. The accuracy of sensing the touch object is affected accordingly.

To overcome the shortcomings, the present invention provides a method for sensing an active stylus on a display device and a device for sensing an active stylus to mitigate or obviate the aforementioned problems.

### SUMMARY OF THE INVENTION

Based on the aforementioned drawbacks of sensing the active stylus in the conventional time-division driving method, an objective of the present invention provides a method for sensing an active stylus on a display device and a device for sensing an active stylus.

To achieve the aforementioned objective, the present invention provides the method for sensing an active stylus on a display device. The display device has multiple sub-pixels and multiple common electrodes respectively corresponding to at least one of the sub-pixels. The method includes:

sensing a signal of an active stylus through one of the common electrodes for displaying an image in a displaying duration of the display device.

To achieve the aforementioned objective, the present invention provides a method for the device to sense an active stylus that is electrically connected to a display device. The display device has multiple sub-pixels, multiple common electrodes respectively corresponding to at least one of the sub-pixels and an image driving unit electrically connected to the sub-pixels. The device for sensing the active stylus has:

a touch sensing unit electrically connected to the common electrodes, wherein in a displaying duration of the display device, the image driving unit drives one of the sub-pixels to display an image and the touch sensing unit senses a signal of an active stylus through one of the common electrodes corresponding to the driven sub-pixel.

Based on the foregoing description, the present invention senses the active stylus during a display panel of the display device displays the image, but does not sense the active stylus in a touch sensing duration for sensing the touch object. As a result, the touch sensing duration is not prolonged to sense the active stylus so the quality of a displaying image is not decreased. Similarly, since the active stylus detection is not executed in the touch sensing duration, the accuracy of sensing the touch object is not affected.

Other objectives, advantages and novel features of the invention will become more apparent from the following detailed description when taken in conjunction with the accompanying drawings.

### BRIEF DESCRIPTION OF THE DRAWINGS

FIG. 1 is a system schematic view of a display device in accordance with the present invention;

FIG. 2A is a structural schematic view of multiple sub-pixels and a common electrode layer of a first embodiment of a display device in accordance with the present invention;

FIG. 2B is a circuit diagram of one of the multiple common electrodes and a corresponding sensing unit in FIG. 2A;

FIG. 3A is a structural schematic view of multiple sub-pixels and a common electrode layer of a second embodiment of a display device in accordance with the present invention;

FIG. 3B is a circuit diagram of one of the multiple common electrodes and a corresponding sensing unit in FIG. 3A;

FIG. 4A is structural schematic view of multiple sub-pixels and a common electrode layer of a third embodiment of a display device in accordance with the present invention;

FIG. 4B is a circuit diagram of one of the multiple common electrodes and a corresponding sensing unit in FIG. 4A;

FIG. 5 is a time sequence diagram for the image display driving and touch sensing of the display device in accordance with the present invention;

FIG. 6A is a voltage waveform diagram showing voltage changes of a display signal of one of the multiple sub-pixels and the common electrode of the display device in accordance with the present invention;

FIG. 6B is a voltage waveform diagram showing voltage changes of the display signal of one of the multiple sub-pixels, the common electrode and a pixel electrode of the display device in accordance with the present invention; and

FIG. 7 is another circuit diagram of one of the multiple common electrodes and the corresponding sensing unit in FIG. 2A.

### DETAILED DESCRIPTION OF THE EMBODIMENTS

The present invention provides a method and a device for sensing a stylus executed during an image displaying period. Many embodiments of the present invention are used to describe a detailed structure of the fingerprint sensor in accordance with the present invention.

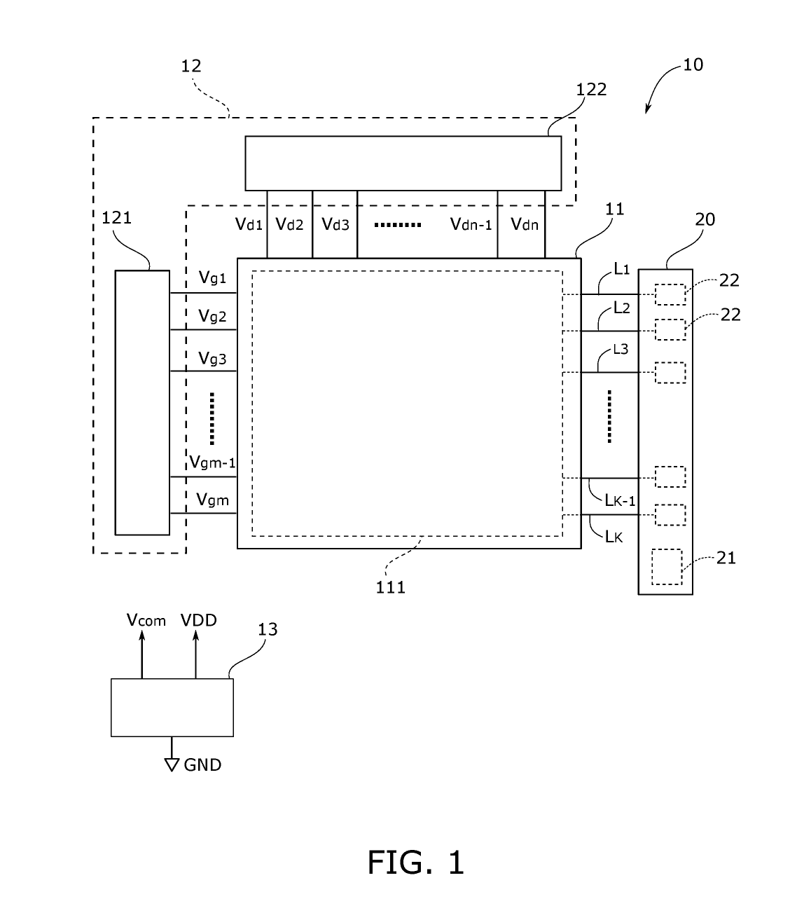

With reference to FIG. 1, a display device 10 of the present invention has a display panel 11, an image driving unit 12, a touch sensing unit 20 and a power circuit 13. The image driving unit 12 has a gate driving unit 121 and a data driving unit 122. The gate driving unit 121, the data driving unit 122 and the touch sensing unit 20 are electrically connected to the display panel 11. The power circuit 13 respectively supplies voltages to the gate driving unit 121, the data driving unit 122 and the touch sensing unit 20.

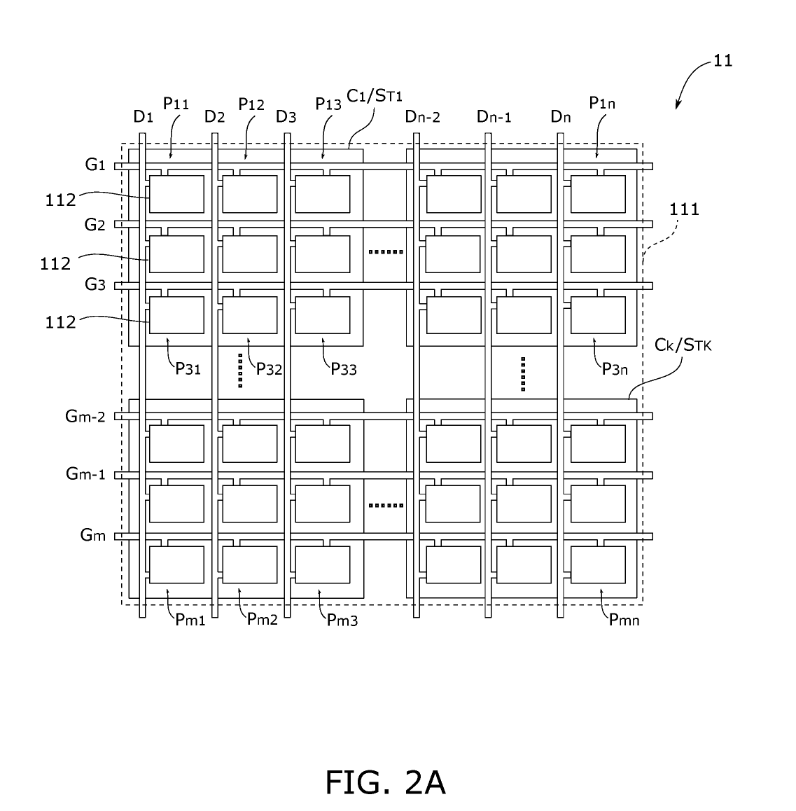

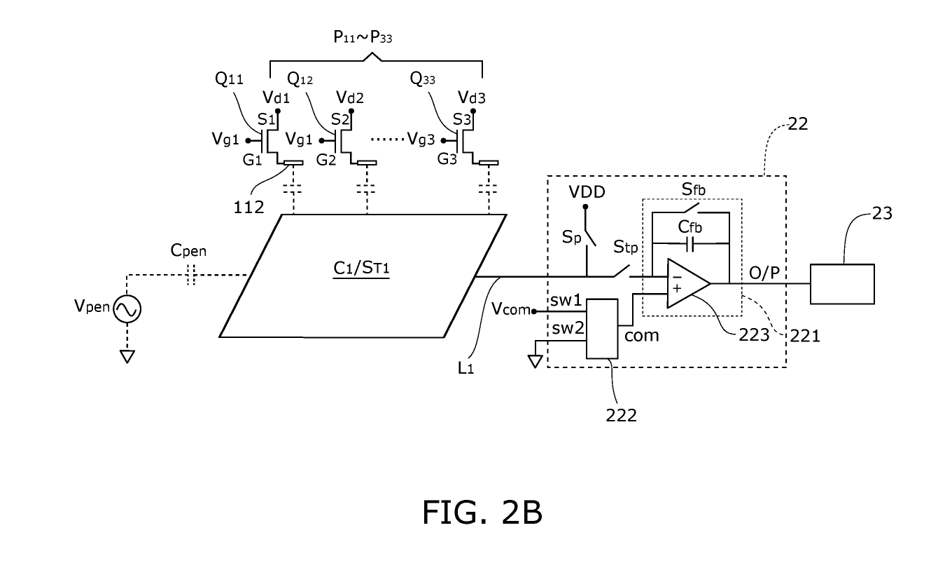

With further reference to FIGS. 1, 2A and 2B, the first embodiment of the display device 10 in accordance with the present invention is shown. The display panel 11 of the display device 10 has multiple gate lines G₁˜Gₘ, multiple data lines D₁˜Dₙ, multiple pixel electrodes 112, multiple thin-film transistors Q₁₁˜Q₁ₙ, Q₂₁˜Q₂ₙ . . . , Qₘ₁˜Qₘₙ, multiple signal lines L₁˜L_{K} and a common electrode layer 111. The gate lines G₁˜Gₘ are electrically connected to the gate driving unit 121, the data lines D₁˜Dₙ are electrically connected to the data driving unit 122. The gate lines G₁˜Gₘ and data lines D₁˜Dₙ are insulated and interlaced to each other to define multiple pixel areas. The pixel areas are arranged in a matrix. As shown in FIG. 2B, each pixel electrode 112 and each thin-film transistor Q₁₁˜Q₁ₙ, Q₂₁˜Q₂ₙ . . . , Qₘ₁˜Qₘₙ are disposed in the corresponding pixel area. A gate, a source and a drain of each thin-film transistor Q₁₁˜Q₁ₙ, Q₂₁˜Q₂ₙ . . . , Qₘ₁˜Qₘₙ are sequentially, respectively and electrically connected to the corresponding gate line G1, G2 . . . , Gₘ, data line D₁, D₂ . . . , Dₙ and the pixel electrode 112 in the corresponding pixel area to constitute to one sub-pixel P₁₁˜P₁ₙ, P₂₁˜P₂ₙ . . . , Pₘ₁˜Pₘₙ. The common electrode layer 111 and the pixel electrodes 112 are insulated and parallel to each other. In the first embodiment, three adjacent sub-pixels are constituted to one display pixel and respectively generate a red light, a green light and a blue light. Take a liquid crystal display device as an example, the pixel electrodes 112 of the three adjacent sub-pixels respectively correspond to a red filter area, a green filter area and a blue filter area of a color filter film. In the first embodiment, each display pixel at least has three pixel electrodes 112. When the display device 10 displays an image, the gate driving unit 121 sequentially drives the gate lines G₁˜Gₘ to be turned on the thin-film transistor Q₁₁˜Q₁ₙ, Q₂₁˜Q₂ₙ . . . , Qₘ₁˜Qₘₙ respectively and electrically connected to the driven gate line G₁˜Gₘ. The thin-film transistor Q₁₁˜Q₁ₙ, Q₂₁˜Q₂ₙ . . . , Qₘ₁˜Qₘₙ driven to be turned on passes a display signal V_{d1}˜V_{dn} outputted from the data driving unit 122 to the corresponding pixel electrode 112 through the corresponding data line D₁˜Dₙ. The display signal determines that the pixel electrode 112 connected to the thin-film transistor Q₁₁˜Q₁ₙ, Q₂₁˜Q₂ₙ . . . , Qₘ₁˜Qₘₙ driven to be turned on generates a specific gray level or color for displaying the image.

In the first embodiment, the common electrode layer 111 is divided into multiple common electrodes C₁˜C_{K} arranged in a matrix. The common electrodes C₁˜C_{K} are respectively and electrically connected to the touch sensing unit 20 through the corresponding signal lines L₁˜L_{K}. Each of the common electrodes C₁, C₂ . . . , C_{K} corresponds to h sub-pixels and h is an integer and larger than one (h>1). To further clearly and easily describe more details of the first embodiment, a common electrode C₁ shown in FIG. 2A is used as an example. The common electrode C₁ corresponds to nine pixel electrodes P₁₁˜P₃₃ and h is equal to 9 (h=9) in the first embodiment. However, an amount of the pixel electrodes corresponding to each common electrode is determined according to a real display resolution of the display panel and a size of the common electrode for a real touch resolution. Preferably, the size of each common electrode matches a size of a single sensing electrode of an individual touch panel.

With reference to FIGS. 1 and 2B, in the first embodiment, the touch sensing unit 20 has a controller 21 and multiple sensing circuits 22, and also has multiple analog to digital converters 23. The sensing circuits 22 are electrically connected to the controller 21 and respectively connected to the corresponding common electrodes C₁˜C_{K} through the signal lines L₁˜L_{K} to sense a signal Vₚₑₙ emitted from an active stylus.

With reference to FIG. 2B, an embodiment of the sensing circuit 22 has a charge sharing circuit 221 and a multiplexer 222. A first input (−) of the charge sharing circuit 221 is connected to the corresponding signal line L₁ through a first switch Sₜₚ, so the first input (−) is coupled to the corresponding common electrode C₁. A second input (+) of the charge sharing circuit 221 is connected to a common terminal com of the multiplexer 222 and an output O/P of the charge sharing circuit 221 outputs a sensing signal. Optionally, the output O/P may further output the sensing signal to the corresponding analog to digital converter 23. The analog to digital converter 23 converts the sensing signal to a specific digital data. A first switching terminal sw1 of the multiplexer 222 is connected to a common voltage Vcom of the power circuit 13 and a second switching terminal sw2 of the multiplexer 222 is connected to ground. The common voltage Vcom is a DC voltage. The charge sharing circuit 221 has an amplifier 223, a capacitor C_{fb} and a second switch S_{fb}. An inverting input (−) is used as the first input and a non-inverting input (+) is used as the second input. The capacitor C_{fb} is connected to the inverting input (−) of the amplifier 223 and the output O/P of the charge sharing circuit 221. The second switch S_{fb} is connected to the capacitor C_{fb} in parallel. The first switch Sₜₚ, the multiplexer 222 and the second switch S_{fb} are electrically connected to the controller 21. The controller 21 controls the first and second switches Sₜₚ, S_{fb} to be turned on or turn off and also controls the common terminal com of the multiplexer 222 to selectively connect to the first and second switching terminals sw1, sw2.

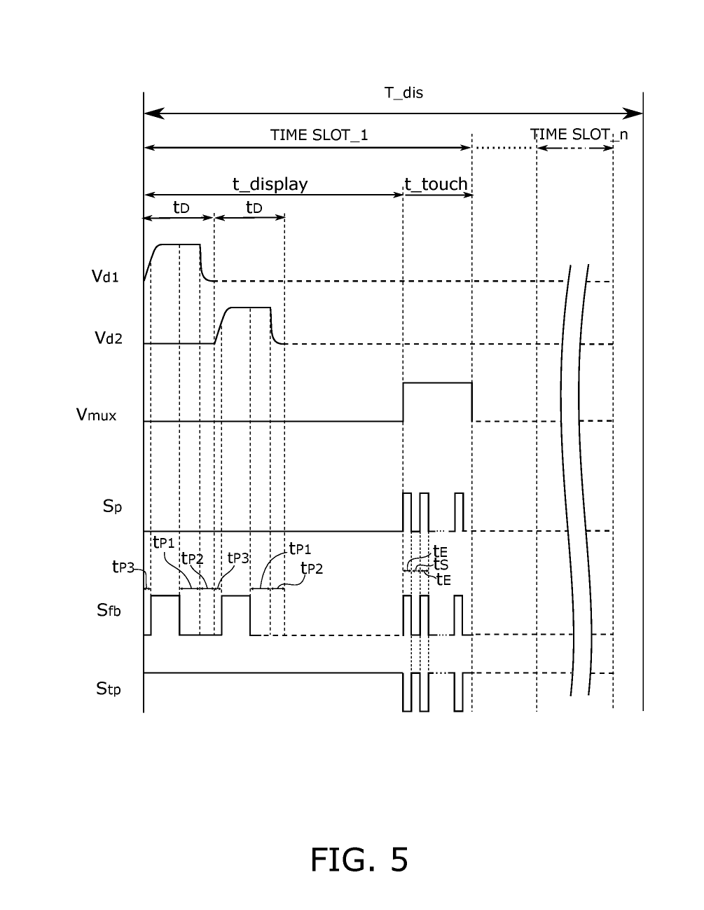

With reference to FIGS. 1, 2B and 5, a flow chart of sensing the active stylus on the display device 10 in accordance with the present invention is further described as follows. The gate driving unit 121 and the data driving unit 122 of the display device 10 drive the sub-pixels P₁₁˜P₁ₙ, P₂₁˜P₂ₙ . . . , Pₘ₁˜Pₘₙ to display images according to an image displaying period T_dis. As shown in FIG. 5, a duration of the image displaying period T_dis is divided into j time slots, wherein j is an integer and larger than one or equal to one. Each time slot is further divided into a displaying duration t_display and a touch sensing duration t_touch adjacent to the displaying duration t_display. The touch sensing duration t_touch can be defined before or after the displaying duration t_display. A display driving procedure is performed in the displaying duration t_display to drive each sub-pixel P₁₁˜P₁ₙ, P₂₁˜P₂ₙ . . . , Pₘ₁˜Pₘₙ for displaying the image. The displaying duration t_display is divided into multiple pixel driving durations t_{D}. In each pixel driving duration t_{D}, the corresponding sub-pixel P₁₁˜P₁ₙ, P₂₁˜P₂ₙ . . . , Pₘ₁˜Pₘₙ is driven to display the image. A touch sensing procedure is performed through the common electrodes C₁˜C_{K} in the touch sensing duration t_touch to sense a touch object, such as a finger or an passive stylus, to obtain sensing information. In the first embodiment, each common electrode C₁˜C_{K} is used as a touch sensing electrode S_{T1}˜S_{TK}.

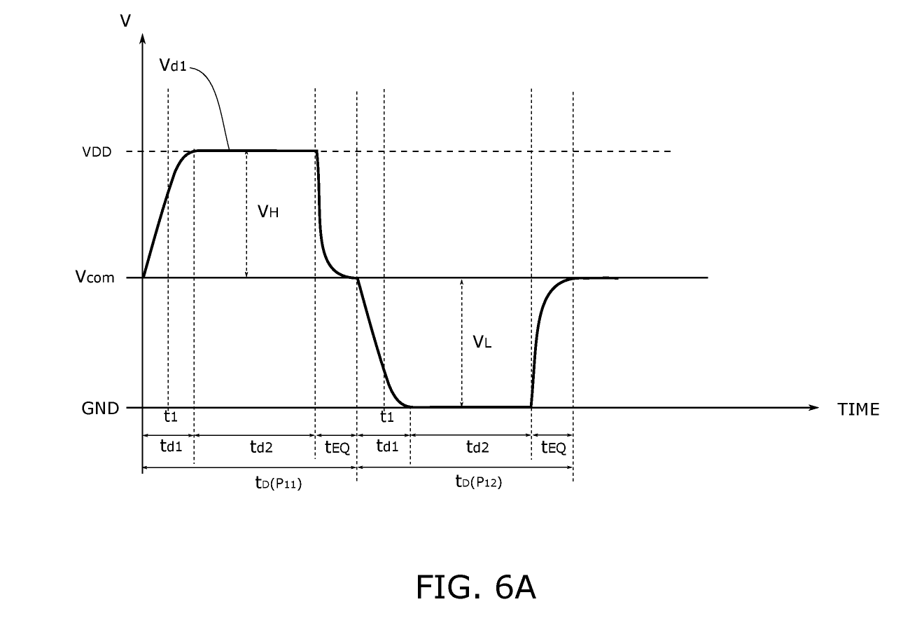

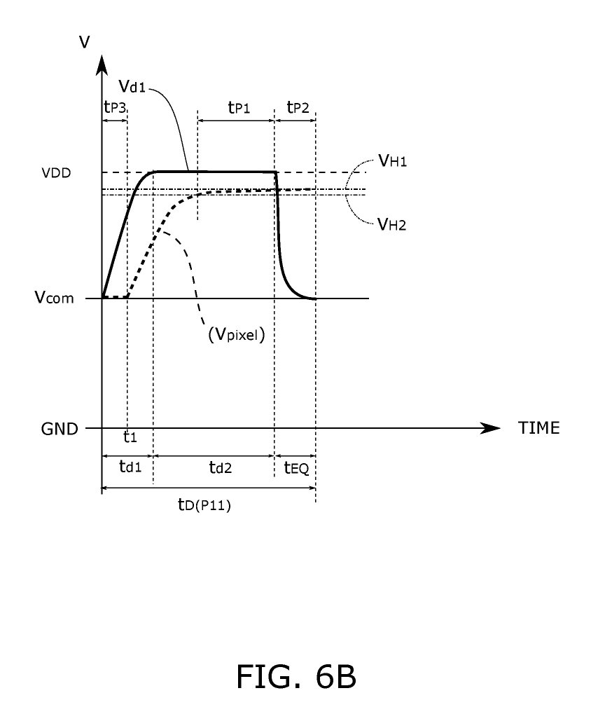

In each displaying duration t_display, the gate driving unit 121 sequentially outputs the gate driving signals V_{g1}˜V_{gm} to the corresponding gate lines G₁˜Gₘ. When the gate driving signal V_{g1} is outputted to the corresponding gate lines G₁, the thin-film transistors Q₁₁˜Q₁ₙ connected to the gate line G₁ is turned on. At the time, the data driving unit 122 provides the display signals V_{d1}˜V_{dn}. The display signals V_{d1}˜V_{dn} are provided to the pixel electrodes 112 through the turned-on thin-film transistors Q₁₁˜Q₁ₙ. In each displaying duration t_display, the three sub-pixels of the display pixel are driven to display the images at the same time or are sequentially driven to display the images according to different types of the display devices. Furthermore, the gate driving unit 121 outputs the gate driving signals V_{g1}, V_{g2} . . . V_{gm} to drive the sub-pixels of the display pixel to display the images and then stops outputting the gate driving signals V_{g1}, V_{g2} . . . V_{gm} after the images are completely formed at the same time, or stops outputting the gate driving signals V_{g1}, V_{g2} . . . V_{gm} after the images are completely formed in sequence. Take the first sub-pixel P₁₁ in FIG. 2B as an example, when the gate driving unit 121 outputs the gate driving signal V_{g1} to the gate line G₁ connected to the corresponding thin-film transistor Q₁₁, the thin-film transistor Q₁₁ is turned on and then the display signal V_{d1} on the corresponding data line D₁ is provided to the pixel electrode 112 connected to the turned-on thin-film transistor Q₁₁. At the time, the controller 21 of the touch sensing unit 20 controls the sensing circuit 22 which is connected to the common electrode corresponding to the first sub-pixel P₁₁. That is, the controller 21 outputs a control signal Vₘᵤₓ to the multiplexer 222 of the sensing circuit 22 and the common terminal com of the multiplexer 222 is then connected to the first switching terminal sw1 to provide the common voltage V_{com} to the common electrode C₁ corresponding to the first sub-pixel P₁₁. In the liquid crystal display device, a liquid crystal layer has multiple liquid crystals and is sandwiched in between the pixel electrode 112 and common electrode C₁ corresponding to the pixel electrode 112. When the display signal V_{d1} is provided to the pixel electrode 112 and the common electrode C₁ is connected to the common voltage V_{com}. At the same time, the liquid crystals start to rotate and change their directions. When a voltage of the pixel electrode 112 reaches a target value, the liquid crystals rotate to a target direction and the first sub-pixel P₁₁ starts to display the image. In the displaying duration t_display, the present invention senses the signal Vₚₑₙ of the active stylus through the common electrode C₁. That is, in the displaying duration t_display, the signal can be sensed by the common electrode C₁ when the voltage Vₚᵢₓₑₗ of the pixel electrode 112 corresponding to the common electrode C₁ is in a stable voltage range defined between an upper voltage V_{H1} and a lower voltage V_{H2}, as shown in FIG. 6B.

With reference to FIG. 6A, a voltage waveform of the display signal V_{d} provided by the data driving unit 122 is shown. When the gate line G₁ of the first sub-pixel P₁₁ is driven at a time point t1, the thin-film transistor Q₁₁ of the first sub-pixel P₁₁ turns on. At that time, the display signal V_{d1} on the data line D₁ connected to the thin-film transistor Q₁₁ is provided to the pixel electrode 112 of the first sub-pixel P₁₁. The voltage of the display signal V_{d1} continuously changes from a positive voltage V_{H} to a negative voltage V_{L}. In the first embodiment, when the thin-film transistor Q₁ of the first sub-pixel P₁₁ is driven to be turned on, the voltage of the display signal V_{d1} is the positive voltage V_{H}. A voltage level of the display signal V_{d1} starts to rise from a starting voltage and then reaches a target voltage after a first period of time t_{d1}. For example, if the first sub-pixel P₁₁ is driven to display a white image, as shown in FIG. 6A, the target voltage of the first sub-pixel P₁₁ is set to a VDD. After a second period of time t_{d2}, the voltage level of the display signal V_{d1} starts to decrease from the target voltage back to the starting voltage. And then, the voltage level of the display signal V_{d1} reaches the starting voltage after a third period of time t_{EQ}. In the first embodiment, the starting voltage of the display signal V_{d1} is the same as the common voltage, but is not limited thereto.

With further reference to FIG. 6B, FIG. 6B is a voltage waveform diagram showing a voltage change of the pixel electrode 112 of the first sub-pixel P₁₁. The liquid crystals between the pixel electrode 112 and the common electrode C1 start to rotate when the voltage level of the display signal V_{d1} starts to change, and then the liquid crystals rotate to a target angle after the second period of time t_{d2}. At the time, the first sub-pixel P₁₁ completely displays the corresponding image and the voltage change of the present voltage level of the pixel electrode 112 is in a voltage undulation range. That is, the voltage Vₚᵢₓₑₗ of the pixel electrode 112 reaches to the stable voltage range (V_{H1}˜V_{H2}). The voltage undulation range is determined according to a voltage undulation range that does not affect the sensing signal generated by detecting the signal Vₚₑₙ of the active stylus. Furthermore, during a third period of time t_{EQ}, the voltage level of the display signal V_{d1} decreases from the target voltage to the starting voltage. The gate line G₁ of the first sub-pixel P₁₁ is not driven in the third period of time t_{EQ}, so the voltage Vₚᵢₓₑₗ of the pixel electrode 112 is maintained in the stable voltage range (V_{H1}˜V_{H2}). In the first embodiment, during the displaying duration t_display, there are two durations when the voltage Vₚᵢₓₑₗ of the pixel electrode 112 is maintained in the stable voltage range. One of the two durations is a first detection duration t_{P1} starting at a time point when the voltage Vₚᵢₓₑₗ of the pixel electrode 112 of the first sub-pixel P₁₁ reaches to the stable voltage range after the first pixel sub-pixel P₁₁ is driven and ending at a time point when the first sub-pixel P₁₁ is not driven anymore. The other duration is a second detection duration t_{P2} starting at the end time of the first detection duration t_{P1} and ending at an end time of the pixel driving duration T_{D}, that is the second detection duration t_{P2} corresponds to the third period of time t_{EQ}. The sensing circuit 22 senses the signal Vₚₑₙ of the active stylus through the common electrode C₁ during the first and/or second detection durations tₚ₁, tₚ₂.

In addition, the gate driving unit 121 requires an initial preparation period t_{P3} (or so called a pre-charging period) for the first sub-pixel P₁₁ to be turned on when the gate line G₁ of the first sub-pixel P₁₁ is driven at the time point t1. In the initial preparation period tₚ₃, the first sub-pixel P₁₁ is not turned on until a target gate voltage on the gate line G₁ is reached. Therefore, the voltage Vₚᵢₓₑₗ of the pixel electrode 112 of the first sub-pixel P₁₁ is maintained at the common voltage level and is kept in the stable voltage range, too. In other words, the voltage Vₚᵢₓₑₗ of the pixel electrode 112 is maintained in the stable voltage range during the initial preparation period t_{P3}, so the present invention can sense the signal Vₚₑₙ of the active stylus through the common electrode C₁ in the initial preparation period t_{P3}. Here, the initial preparation period t_{P3} is a third detection of time t_{P3}. Therefore, in the displaying duration t_display, the signal Vₚₑₙ of the active stylus can be sensed by the common electrode C₁ when the voltage Vₚᵢₓₑₗ of the pixel electrode 112 corresponding to the common electrode C₁ keeps in the stable voltage range. In the first embodiment, the initial preparation period t_{P3} overlaps but is less than the first period of time t_{d1}, and starts at a starting time of the pixel driving time T_{D} and ends before a time when the voltage Vₚᵢₓₑₗ of the pixel electrode 112 of the first sub-pixel P₁₁ starts to change.

The multiple sub-pixels P₁₁˜P₁ₙ, P₂₁˜P₂ₙ . . . , Pₘ₁˜Pₘₙ respectively display different color images according to different voltages of the display signals V_{d1}˜V_{dn} respectively provided to the multiple sub-pixels P₁₁˜P₁ₙ, P₂₁˜P₂ₙ . . . , Pₘ₁˜Pₘₙ. That is, the target values for the pixel electrodes 112 of the sub-pixels P₁₁˜Pᵢₙ, P₂₁—P₂ₙ . . . , Pₘi-Pₘₙ displaying different color images are different, too. Therefore, after the sub-pixels P₁₁˜P₁ₙ, P₂₁˜P₂ₙ . . . , Pₘ₁˜Pₘₙ are driven, raising times from the starting voltages thereof respectively to the corresponding target values are different, so the first and the second detection durations t_{P1}, t_{P2} of the sub-pixels P₁₁˜P₁ₙ, P₂₁˜P₂ₙ . . . , Pₘ₁˜Pₘₙ are different, too. Therefore, the starting times of the first detection durations t_{P1} for different sub-pixels P₁₁˜P₁ₙ, P₂₁˜P₂ₙ . . . , Pₘ₁˜Pₘₙ are different when the display signals V_{d1}˜V_{dn} with different voltages or different target values are provided to the corresponding sub-pixels P₁₁˜P₁ₙ, P₂₁˜P₂ₙ . . . , Pₘ₁˜Pₘₙ. In one embodiment, the sensing circuit 22 may determine the starting times of the first detection durations tpl of all of the sub-pixels P₁₁˜P₁ₙ, P₂₁˜P₂ₙ . . . , Pₘ₁˜Pₘₙ according to the voltages of the display signals V_{d1}˜V_{dn} respectively obtained by the currently-driven sub-pixels P₁₁˜P₁ₙ, P₂₁˜P₂ₙ . . . , Pₘ₁˜Pₘₙ. In another embodiment, the sensing circuit 22 may determine a common first detection duration t_{P1} for all sub-pixels P₁₁˜P₁ₙ, P₂₁˜P₂ₙ . . . , Pₘ₁˜Pₘₙ, wherein the common first detection t_{P1} is determined according to the raising time (charging time) of a highest stable voltage V_{Hmax} of the pixel electrode 112 or a falling time (discharging time) of a lowest stable voltage V_{Lmin} of the pixel electrode 112. That is, regardless of a magnitude of the voltage or the target value of the display signals V_{d1}˜V_{dn} obtained by the currently-driven sub-pixels P₁₁˜P₁ₙ, P₂₁˜P₂ₙ . . . , Pₘ₁˜Pₘₙ, the starting time of the common first detection duration t_{P1} is the time when the voltage Vₚᵢₓₑₗ of the pixel electrode 112 of each of the currently-driven sub-pixels P₁₁˜P₁ₙ, P₂₁˜P₂ₙ . . . , Pₘ₁˜Pₘₙ in the pixel driving duration t_{D} has been in the stable voltage range. Accordingly, no matter what color images are displayed by the driven sub-pixels P₁₁˜P₁ₙ, P₂₁˜P₂ₙ . . . , Pₘ₁˜Pₘₙ, each of the sensing circuits 22 may sense the signal Vₚₑₙ of the active stylus when the voltage Vₚᵢₓₑₗ of the pixel electrode 112 of each of the currently-driven sub-pixels P₁₁˜P₁ₙ, P₂₁˜P₂ₙ . . . , Pₘ₁˜Pₘₙ is in the stable voltage range.

With reference to FIGS. 2B, 5, 6A and 6B, the first, second and third detection durations t_{P1}, t_{P2}, t_{P3} are in the displaying duration t_display, so the present invention senses the signal Vₚₑₙ of the active stylus during the voltage Vₚᵢₓₑₗ of the pixel electrode 112 of the first sub-pixel P₁₁ in the stable voltage range. That is, when the active stylus approaches to the common electrode C₁ corresponding to the first sub-pixel P₁₁, a capacitor Cₚₑₙ is electrically coupled between the active stylus and the common electrode C₁. At the same time, the signal Vₚₑₙ of the active stylus changes an amount of charges in the capacitor Cₚₑₙ and the sensing circuit 22 which is electrically connected to the common electrode C₁ may sense the signal Vₚₑₙ of the active stylus accordingly. Particularly, to avoid an interference from the display signal V_{d1} provided to the first sub-pixel P₁₁, the controller 21 controls the sensing circuit 22 that senses an approach of the active stylus in the first, second and/or initial preparation durations t_{P1}, t_{P2}, t_{P3}.

With reference to FIGS. 5, 6A and 6B, in the displaying duration t_display, the controller 21 controls the first switch Sₜₚ to be turned on and to electrically connect the sensing circuit 22 and the common electrode C₁. The second switch S_{fb} is also controlled to be turned on by the controller 21 to remove the charges in the capacitor C_{fb}. At the time, the common terminal com of the multiplexer 222 is connected to the first switching terminal sw1. However, in the first, second and/or initial preparation durations t_{P1}, t_{P2}, t_{P3}, the controller 21 controls the second switch S_{fb} to turn off. At the same time, if the active stylus approaches to the common electrode C₁, as shown in FIG. 2B, the signal Vₚₑₙ of the active stylus changes the amount of charges in the capacitor Cₚₑₙ between them. Since the first switch Sₜₚ turns on but the second switch S_{fb} turns off, the charges in the capacitor Cₚₑₙ are transferred to the capacitor C_{fb} of the charge sharing circuit 221. The amplifier 223 outputs the sensing signal to the corresponding analog to digital converter 23 based on the amount of charges in the capacitor C_{fb}. Therefore, the approach of the active stylus to the first sub-pixel P₁₁ may be determined.

In each displaying duration t_display, a first sub-pixel P₁₁ is selected to be driven. The voltage Vₚᵢₓₑₗ of the pixel electrode 112 of the selected first sub-pixel P₁₁ is maintained in the stable voltage range during the first, second and initial preparation durations t_{P1}, t_{P2}, t_{P3}, so the present invention can sense the signal Vₚₑₙ of the active stylus by the common electrode C₁ corresponding to the driven first sub-pixel P₁₁ in the first, second and initial preparation durations t_{P1}, t_{P2}, t_{P3}.

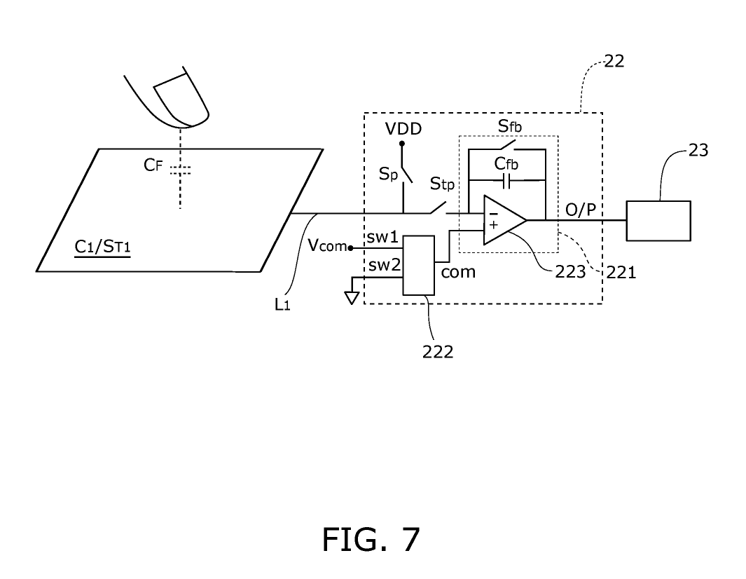

With reference to FIGS. 1, 2B and 5, a touch scanning procedure is executed in the touch sensing duration t_touch to obtain touch information by sensing a touch object, such as a finger or a passive stylus. In the touch sensing duration t_touch, the gate driving unit 121 does not output the gate signal V_{g1}˜V_{gm} to the thin-film transistors Q₁₁˜Q₁ₙ, Q₂₁˜Q₂ₙ . . . , Qₘ₁˜Qₘₙ and the data driving unit 122 does not output the display signal V_{d1}˜V_{dn} to the thin-film transistors Q₁₁˜Q₁ₙ, Q₂₁˜Q₂ₙ . . . , Qₘ₁˜Qₘₙ, either. The touch sensing duration t_touch has a driving phase t_{E} and a sensing phase t_{S}. Each of the sensing circuit 22 further has a third switch S_{P} electrically connected to the signal line L₁ of the sensing circuit 22 and a driving voltage VDD. As shown in FIG. 5, in the driving phase T_{E} of the touch sensing duration t_touch, the controller 21 outputs a control signal Vₘᵤₓ to the multiplexer 222 of the sensing circuit 22 to connect the common terminal com to the second switching terminal sw2, so the second input (+) of the amplifier 223 is connected to ground. At the same time, the second switch S_{fb} and the third switch S_{P} are controlled to be turned on and the first switch Sₜₚ is controlled to be turned off, so the driving voltage VDD is supplied to the common electrode C₁ which is connected to the sensing circuit 22. At the same time, as shown in FIG. 7, if the finger or the passive stylus approaches to the common electrode C₁, a capacitor C_{F} is electrically coupled between them. Next go to the sensing phase T_{S}, the controller 21 controls the second switch S_{fb} and the third switch S_{P} to be turned off and keeps the first switch St_{P} in a turn-off status, so the charges in the capacitor C_{F} are transferred to the capacitor C_{fb} of the charge sharing circuit 221. The output O/P of the amplifier 223 outputs the sensing signal corresponding to the amount of charges in the capacitor C_{fb} and the sensing signal is used as the touch information. Therefore, the charge sharing circuit 221 senses the approach or the touch of a finger or passive stylus through the common electrode C₁.

Based on the foregoing description, the first embodiment of the display device 10 in accordance with the present invention can sense the active stylus during the display panel 11 displays the images. In other words, the active stylus sensing procedure of the present invention is not performed in the touch sensing duration t_touch for performing the touch sensing procedure. Therefore, the displaying duration t_display is not shortened to perform the active stylus sensing procedure and the quality of displaying image is not affected. Similarly, the touch sensing duration t_touch is not divided into another duration to sense the active stylus, so the accuracy of sensing the touch object is not affected.

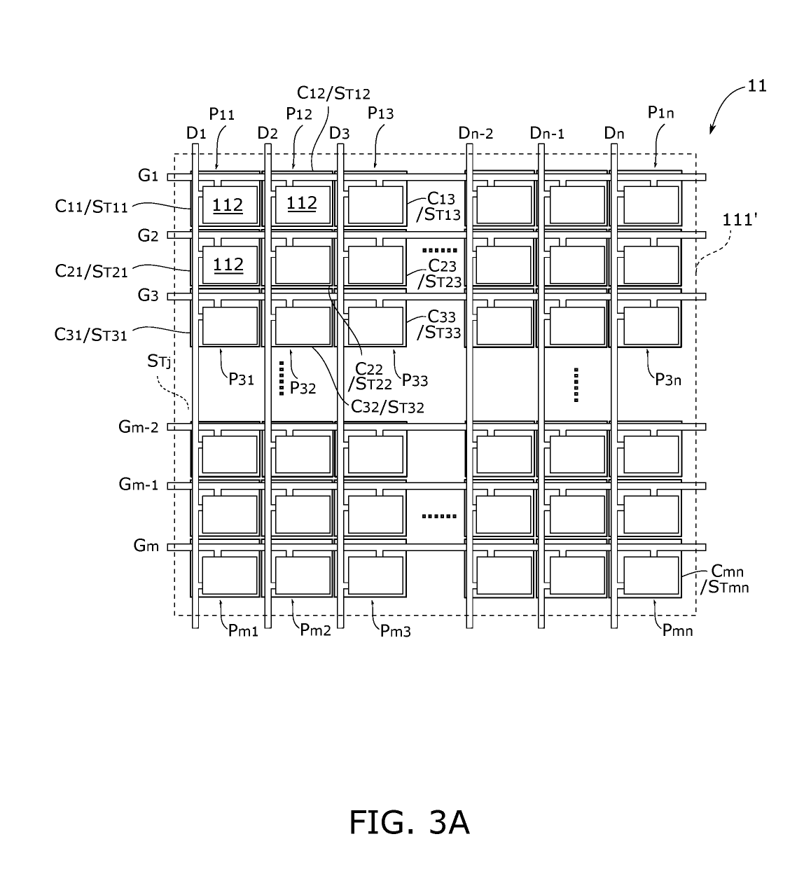

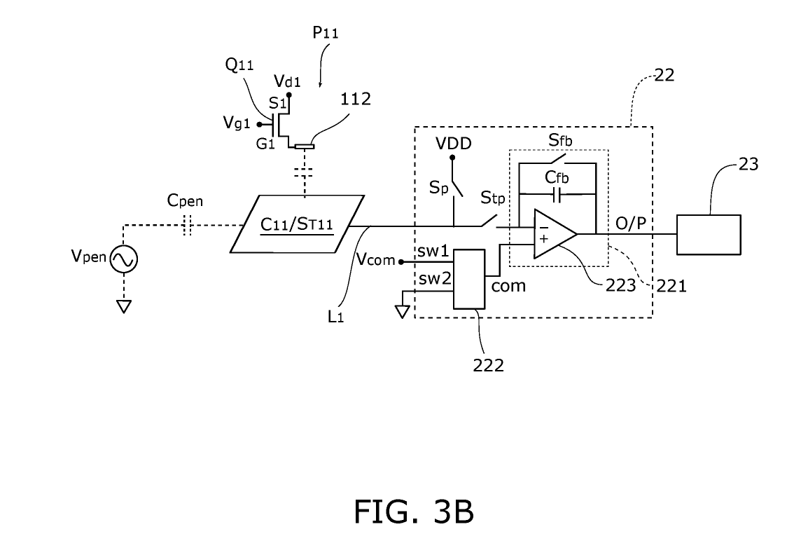

With reference to FIG. 3A, a second embodiment of the display device 10 of the present invention is shown and is similar to the first embodiment. In the second embodiment, each of the common electrodes C₁˜C_{K} of the first embodiment is further divided into multiple common electrodes C₁₁˜Cₘₙ, each of which corresponds to one sub-pixel P₁₁˜P₁ₙ, P₂₁˜P₂ₙ . . . , Pₘ₁˜Pₘₙ. Relatively, the second embodiment requires more signal lines L₁˜L_{K} and sensing circuit 22, as shown in FIG. 1. With reference to FIGS. 3B and 5, in the second embodiment, a controlling procedure of the controller 21 in first, second and initial detection durations t_{P1}, t_{P2}, t_{P3} of the displaying duration t_display is the same as that of the first embodiment, so the same controlling procedure is not necessary to describe here. In the second embodiment, each of the common electrodes C₁₁˜Cₘₙ is also individually used as a touch sensing electrode. In comparison with the first embodiment, an accuracy and resolution of sensing the active stylus or the touch object are increased, since the common electrode layer 111′ is further divided into more common electrodes C₁₁˜Cₘₙ corresponding to the sub-pixels P₁₁˜P₁ₙ, P₂₁˜P₂ₙ . . . , Pₘ₁˜Pₘₙ in the second embodiment. Such structure of the second embodiment may be used in different applications.

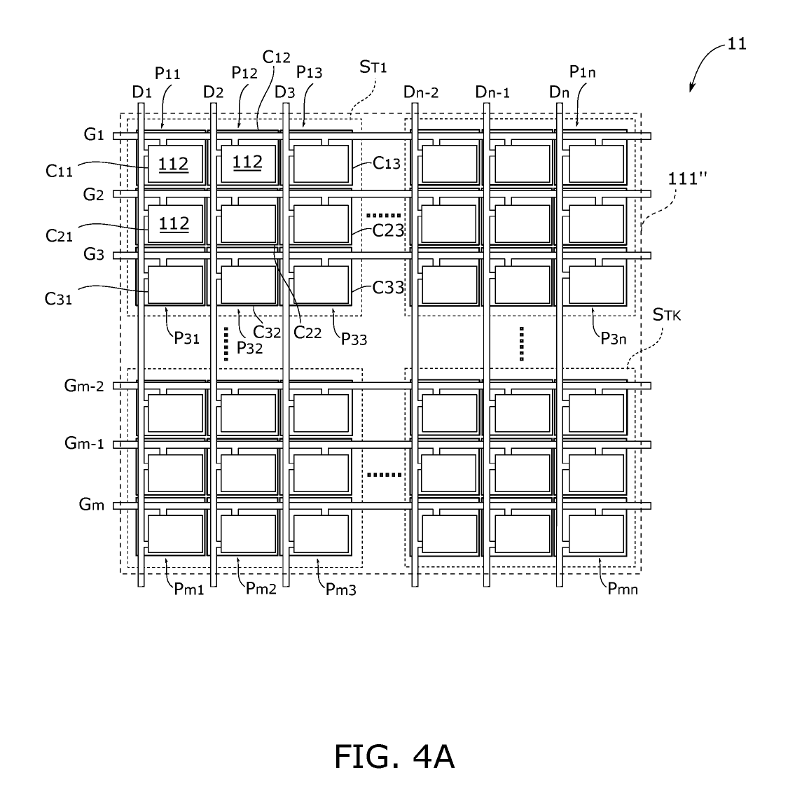

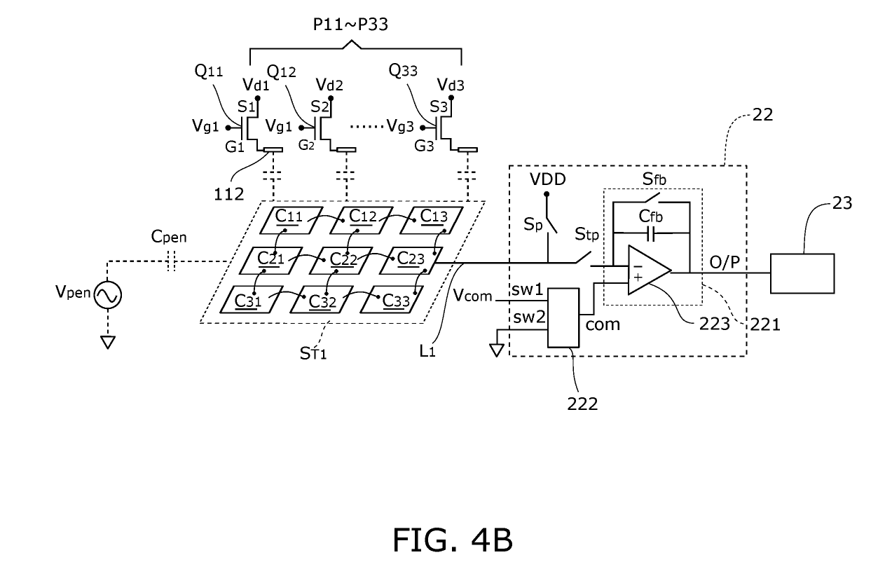

With reference to FIG. 4A, a third embodiment of the display device 10 of the present invention is shown. Similar to the second embodiment, in the third embodiment, the common electrode layer 111″ is also divided into more common electrodes C₁₁˜Cₘₙ and each of the common electrodes C₁₁˜Cₘₙ corresponds to one of the sub-pixels P₁₁˜P₁ₙ, P₂₁˜P₂ₙ . . . , Pₘ₁˜Pₘₙ, but one common electrode C₁₁, C₁₂ . . . , Cₘₙ is not individually used as a touch sensing electrode S_{T1}˜S_{TK}. Each of the touch sensing electrodes S_{T1}˜S_{TK} of the third embodiment has h common electrodes adjacent to each other, which are arranged in a matrix and are electrically connected to each other, wherein h is an integer and larger than one (h>f1). For example, the common electrodes C₁₁˜C₃₃ are electrically connected in serial to use as the touch sensing electrode S_{T1}. With reference to FIGS. 1 and 4B, in the display panel 11, the common electrodes C₁₁˜C₃₃ are electrically connected in serial. The sensing circuits 22 are respectively and electrically connected to the common electrode C₁₁˜Cₘₙ of the corresponding touch sensing electrodes S_{T1}˜S_{TK} through the corresponding signal line L₁˜L_{K}. That is, the sensing circuit 22 is electrically connected to all of the common electrodes C₁₁˜C₃₃ of the corresponding touch sensing electrode S_{T1} through the signal line L₁. With further reference to FIGS. 4B and 5, in the third embodiment, the controlling procedure of the controller 21 executed in the first, second and initial detection durations t_{P1}, T_{P2}, t_{P3} of the displaying duration t_display is the same as that of the first embodiment, so the same controlling procedure is not necessary to describe here. In the third embodiment, the amount of charges in the capacitor C_{fb} of the charge sharing circuit 223 are transferred from all of the common electrodes C₁₁˜C₃₃ of the corresponding touch sensing electrode S_{T1}, so the charge sharing circuit 223 senses the charge change of all of the common electrodes C₁₁˜C₃₃ of the corresponding touch sensing electrode S_{T1}. Furthermore, an amount of the common electrodes (h) may be determined according to the size of a touch sensing electrode. Therefore, the present invention also has a better design margin for practical adjustment of the desired resolution.

Based on the foregoing embodiments, a method for sensing the active stylus is performed in the displaying duration for displaying image, but not in the touch sensing duration for sensing the touch object. As a result, the displaying duration is not shortened to perform the active stylus sensing procedure and the quality of displaying image is not affected. Similarly, the touch sensing duration is not divided into another duration to sense the active stylus and the accuracy of sensing the touch object is not affected.

Even though numerous characteristics and advantages of the present invention have been set forth in the foregoing description, together with the details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for sensing an active stylus on a display device, wherein the display device comprises multiple sub-pixels and multiple common electrodes respectively corresponding to at least one of the sub-pixels, and the method comprises:
sensing a signal of an active stylus through one of the common electrodes for displaying an image in a displaying duration of the display device.

2. The method as claimed in claim 1, wherein the displaying duration has a pixel driving duration, and in the pixel driving duration, one of the sub-pixels having a pixel electrode is driven for displaying the image, and the common electrode corresponding the driven sub-pixel is used to sense the signal of the active stylus when a voltage of the pixel electrode is in a stable voltage range; wherein the stable voltage range is defined bewteen an upper voltage and a lower voltage.

3. The method as claimed in claim 2, the pixel driving duration having a first detection duration, wherein in the first detection duration, the common electrode which corresponds to the driven sub-pixel is used to sense the signal of the active stylus, wherein the first detection duration starts at a first time when the voltage of the pixel electrode of the driven sub-pixel reaches to the stable voltage range and ends at a second time when the driven sub-pixel is not driven.

4. The method as claimed in claim 3, the pixel driving duration further has a second detection duration, wherein in at least one of the first and second detection durations, the common electrode corresponding to the driven sub-pixel is used to sense the signal of the active stylus, wherein the second detection duration starts at an end time of the first detection duration and ends at an end time of the pixel driving duration.

5. The method as claimed in claim 2, the pixel driving duration has a third detection duration, wherein in the third detection duration, the common electrode corresponding to the driven sub-pixel is used to sense the signal of the active stylus, wherein the third detection duration starts at a starting time of the pixel driving duration and ends at a time point when the voltage of the pixel electrode of the driven sub-pixel starts to change.

6. The method as claimed in claim 2, wherein each of the common electrodes of the display device respectively corresponds to one of the sub-pixels having the pixel electrode, and a plurality of the common electrodes adjacent to each other are electrically connected in serial to use as a touch sensing electrode, wherein
in the displaying duration, at least one of the sub-pixels having the pixel electrode is driven and the touch sensing electrode including at least one of the common electrodes corresponding to the at least one driven sub-pixel is used to sense the signal of the active stylus when the voltage of the pixel electrode of the at least one driven sub-pixel reaches to the stable voltage range.

7. The method as claimed in claim 1, further comprising a touch sensing duration of the display device adjacent to the displaying duration, wherein
in the touch sensing duration, a driving voltage is outputted to the common electrodes and touch information obtained by sensing a touch object through the common electrodes is outputted.

8. The method as claimed in claim 1, wherein in the displaying duration, the common electrode for displaying the image is connected to a common voltage and the common voltage is a DC voltage.

9. A device for sensing active stylus, electrically connected to a display device having multiple sub-pixels, multiple common electrodes respectively corresponding to at least one of the sub-pixels and an image driving unit electrically connected to the sub-pixels, wherein the device for sensing active stylus comprises:
a touch sensing unit electrically connected to the common electrodes, wherein in a displaying duration of the display device, the image driving unit drives one of the sub-pixels to display an image and the touch sensing unit senses a signal of an active stylus through one of the common electrodes corresponding to the driven sub-pixel.

10. The device as claimed in claim 9, the displaying duration having at least one pixel driving duration, wherein in the pixel driving duration, when the image driving unit drives one of the sub-pixels having a pixel electrode to display the image, the touch sensing unit senses the signal of the active stylus through the common electrode corresponding the driven sub-pixel when a voltage of the pixel electrode of the driven sub-pixel is in a stable voltage range; wherein the stable voltage range is defined between an upper voltage and a lower voltage.

11. The device as claimed in claim 10, the pixel driving duration having a first detection duration, wherein in the first detection duration, the touch sensing unit senses the signal of the active stylus through the common electrode corresponding to the driven sub-pixel, wherein the first detection duration starts at a first time when the voltage of the pixel electrode of the driven sub-pixel reaches the stable voltage range and ends at a second time when the driven sub-pixel is not driven.

12. The device as claimed in claim 11, wherein the pixel driving duration further has a second detection duration, wherein in at least one of the first and second detection durations, the touch sensing unit senses the signal of the active stylus through the common electrode corresponding to the driven sub-pixel, wherein the second detection duration starts at an end time of the first detection duration and ends at an end time of the pixel driving duration.

13. The device as claimed in claim 10, wherein the pixel driving duration has a third detection duration, wherein in the third detection duration, the touch sensing unit senses the signal of the active stylus through the common electrode corresponding to the driven sub-pixel, wherein the third detection duration starts at a starting time of the pixel driving duration and ends at a time point when the voltage of the pixel electrode of the driven sub-pixel starts to change.

14. The device as claimed in claim 10, wherein the touch sensing unit presets a common first detection duration, wherein the common first detection duration is determined according to a charging time required by a highest stable voltage or a discharging time required by a lowest stable voltage.

15. The device as claimed in claim 11, wherein each of the common electrodes respectively corresponds to one of the sub-pixels and a plurality of the common electrodes adjacent to each other are electrically connected in serial to use as a touch sensing electrode for sensing the signal of the active stylus.

16. The device as claimed in claim 11, the touch sensing unit comprising a controller and multiple sensing circuits electrically connected to the controller, the sensing circuits respectively and electrically connected to the common electrodes, wherein each of the sensing circuit comprises:
a charge sharing circuit having a first input, a second input and an output, wherein the first input is connected to the common electrode corresponding to the sensing circuit through a first switch, the second input is selectively connected to a common voltage or a ground, and the output outputs a sensing signal corresponding to the signal of the active stylus;
wherein the charge sharing circuit and the first switch are respectively connected to controller and in the displaying duration, the controller controls the charge sharing circuit to connect the second input to the common voltage and turns on the first switch to connect electrically the first input of the charge sharing circuit to the common electrode corresponding to the sensing circuit.

17. The device as claimed in claim 16, the charge sharing circuit comprising:
an amplifier having an inverting input and a non-inverting input;
a capacitor connected between the inverting input and the output; and
a second switch connected to the capacitor in parallel and electrically connected to the controller, wherein the controller controls the second switch to turn off in the displaying duration.

18. The device as claimed in claim 17, wherein the touch sensing unit outputs a driving voltage to the common electrodes in a touch sensing duration adjacent to the displaying duration and outputs touch information after sensing a touch object through the common electrodes.

19. The device as claimed in claim 18, wherein the charge sharing circuit further comprises a third switch connected between the driving voltage and the common electrode corresponding to the sensing circuit, wherein the third switch is electrically connected to the controller, wherein the touch sensing duration has a driving phase and a sensing phase, wherein
in the driving phase, the controller controls the third switch to be turned on to provide the driving voltage to the common electrode corresponding the turned-on third switch, the first switch to turn off and the second switch to be turned on at the same time; and
in the sensing phase, the controller controls the third switch to turn off, the first switch to be turned on and the second switch to turn off at the same time.

20. The device as claimed in claim 16, the common voltage is a DC voltage.
